(19) United States
(12) Patent Application Publication
(10) Pub. No.: US 2008/0147532 A1
(43) Pub. Date: Jun. 19, 2008

(54) System and Methods for Transferring Tax Credits

(76) Inventors: Simon M. Horsman, Venice, CA (US); Stephen H. Margolis, London (GB); Joseph B. Darby, Watertown, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 11/960,071

(22) Filed: Dec. 19, 2007

Related U.S. Application Data
(60) Provisional application No. 60/875,738, filed on Dec. 19, 2006.

(51) Int. Cl. G06Q 40/00

(52) U.S. Cl. 705/37

(57) ABSTRACT

A system and methods for transferring tax credits from one party to another are disclosed. A system for transferring tax credits includes a system layer receiving at least one bid from at least one bidder for a plurality of tax credits, the system layer connecting the at least one bidder to an application layer via a communications path and forwarding the at least one bid to the application layer; the application layer determining whether the at least one bid from the at least one bidder is a bid which is highest for the plurality of tax credits; and a display displaying the highest bid for the plurality of tax credits.

### RELATED APPLICATIONS

This application claims the benefit of U.S. Provisional Application Ser. No. 60/875,738, filed on Dec. 19, 2006, the entirety of which is hereby incorporated herein by reference for the teachings therein.

### FIELD

The embodiments disclosed herein relate generally to tax credits, and more particularly to systems and methods for acquiring, validating, and utilizing tax credits, offering the same for sale, and transferring tax credits from one party to another.

### BACKGROUND

The US federal government, the governments of other countries, most or all US states, and some US and non-US city governments, offer various forms of tax credit that may be applied in various ways, for example, on a “dollar-for-dollar” basis, against tax liabilities owed to that applicable taxing jurisdiction. Many of these jurisdictions allow a party eligible to claim a tax credit to transfer the same to another, such as a taxpayer, who may be able to use it, or a middleman, who may resell the credit. A tax credit is a direct, dollar-for-dollar reduction in tax liability, as distinguished from a tax deduction, which is generally a deduction against taxable income and therefore reduces taxes only by the percentage equal to the deducting taxpayer's marginal rate on each incremental dollar of income. For example, if a taxpayer owed $50,000 in tax, and the taxpayer took advantage of an $11,000 tax credit against such tax liability, the taxpayer would then owe $39,000, i.e. $50,000−$11,000.

A taxpayer may qualify for a variety of different types of tax credits, which are often made available in order to promote, encourage and/or protect certain desired activity, conduct or behavior. Under the US Internal Revenue Code of 1986, as amended (the “Code”), examples of tax credits at the federal level include tax credits for alcohol used as fuel (Code §40), for increasing research activities (Code §41), a low-income housing tax credit (Code §42), a rehabilitation tax credit (Code §47), an energy credit (Code §48), and a variety of other tax credits. Similarly, many US states offer a variety of credits, some of which conform to and promote activities also encouraged by federal tax credits, e.g., low-income housing, while other state tax credits are aimed to attract, foster or encourage specific activity within that state, e.g., film and television production credits.

Tax credits have been the subject of prior publications and patents, including U.S. Pat. No. 6,542,875 entitled “Charitable and public funding using tax credits and passive losses,” U.S. Pub. No. 2002/0010674 entitled “Method of providing tax credits and property rental and purchase,” and U.S. Pub. No. 2005/0131725 entitled “Mapping algorithm for identifying data required to file for state and federal tax credits related to enterprise zones.”

Presently, tax credits, to the extent they are transferable, are typically transferred through informal or formal brokering services, through investment in a credit-producing activity, and/or through an existing relationship between two parties. Thus, there is a need for a more efficient and easily accessible system and method for transferring tax credits.

### SUMMARY

Embodiments of the present invention may overcome the drawbacks associated with the prior art by providing a system for transferring tax credits. Systems and methods for providing a system for transferring tax credits are disclosed herein.

According to aspects illustrated herein, there is provided a system for transferring tax credits including a system layer receiving at least one bid from at least one bidder for a plurality of tax credits, the system layer connecting the at least one bidder to an application layer via a communications path and forwarding the at least one bid to the application layer; the application layer determining whether the at least one bid from the at least one bidder is a bid which is highest for the plurality of tax credits; and a display displaying the highest bid for the plurality of tax credits.

According to aspects illustrated herein, there is provided a method for transferring tax credits including offering a plurality of tax credits for sale; starting a bid time period; qualifying at least one bidder to bid on the plurality of tax credits; receiving at least one bid from the at least one bidder for the plurality of tax credits; displaying bids from lowest to highest for the plurality of tax credits; ending the bid time period; determining at least one winning bid for the plurality of tax credits based on the which bid was highest; and transferring the plurality of tax credits to at least one winning bidder who submitted the at least one winning bid upon payment of the at least one winning bid.

According to aspects illustrated herein, there is provided a method for transferring tax credits including receiving a plurality of tax credits for sale; fragmenting the plurality of tax credits into one or more groups of tax credits; starting a bid time period for the one or more groups of tax credits; qualifying at least one bidder to bid on the one or more groups of tax credits; receiving at least one bid from the at least one bidder for a selected group of tax credits from the one or more groups of tax credits; displaying bids from lowest to highest for the selected group of tax credits; ending the bid time period; determining at least one winning bid for the selected group of tax credits based on at least one bid which is highest; and transferring the selected group of tax credits to at least one winning bidder submitting the at least one winning bid.

Various embodiments provide certain advantages. Not all embodiments of the invention share the same advantages and those that do may not share them under all circumstances. Further features and advantages of the embodiments, as well as the structure of various embodiments are described in detail below with reference to the accompanying drawings.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 is a block diagram of an illustrative embodiment of a process of a Seller transferring/selling tax credits;

FIG. 2 is a block diagram of an illustrative embodiment of a process of a Bidder purchasing tax credits;

FIG. 3 is a block diagram of an illustrative embodiment of a process of transferring tax credits between a Seller and a Bidder;

FIG. 4 is a block diagram of an illustrative embodiment of a process of bundling and collectively transferring/selling tax credits;

FIG. 5 is a block diagram of an illustrative embodiment of components of a network used to transfer tax credits;

FIG. 6 is a block diagram of an illustrative embodiment of a process of fragmenting tax credits;

FIG. 7 is a block diagram of an illustrative embodiment of a process of evaluating the value of a specific amount of tax credits in a specified jurisdiction;

FIG. 8 is a block diagram of an illustrative embodiment of a process for Seller allocation;

FIG. 9 is a block diagram of an illustrative embodiment of a process for Bidder allocation;

FIG. 10 is a block diagram of an illustrative embodiment of a process of reverse auction; and

FIG. 11 is a block diagram of an illustrative embodiment of a process of real-time tax credit exchange.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The inventions are not limited in their application to the details of construction and the arrangement of components set forth in the following description or illustrated in the drawings. The inventions are capable of being arranged in other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Aspects of the inventions are described below with reference to illustrative embodiments. It should be understood that reference to these illustrative embodiments is not made to limit aspects of the inventions in any way. Instead, illustrative embodiments are used to aid in the description and understanding of various aspects of the inventions. Therefore, the following description is intended to be illustrative, not limiting.

The presently disclosed embodiments provide a more efficient mechanism for the identification, promotion, transferability, and utilization of tax credits, and thus more fully realize and achieve the societal goals being promoted by such tax credits. To this end, the presently disclosed embodiments create an electronic system that interfaces with potentially eligible taxpayers and/or their agents, representatives and advisors, incorporates legal requirements for eligibility to use tax credits and legal restrictions on transferability, and provides a fast and efficient mechanism for the transfer of tax credits at an efficiently determined market price through the creation of a “virtual” electronic market place.

A tax credit, whether issued at the state or federal level, and regardless of national jurisdiction, generally results in a dollar-for-dollar reduction in specified tax liabilities. In some cases, tax credits may be carried forward or backward from one tax year to another, while in other cases, such credits expire worthless if not used in a specific tax year. Certain “non-refundable” tax credits may be used solely to reduce the amount of tax due and payable at a particular time, while “refundable” tax credits can result in a cash payment to a taxpayer equal to the amount of any unused tax credits. Depending on the law of the jurisdiction creating and establishing a transferable tax credit, such credit may be transferable from a business to an individual, from an individual to a business, from a business to a business, or from an individual to an individual.

Transferring tax credits via the disclosed method may enable a transferor of the tax credits (hereinafter the “Seller”) to reach a much larger audience and, as a result, the selling price for the tax credits may increase through creation of a competitive environment (i.e., a bidding process). The system may also permit potential purchasers, who might not otherwise know about tax credits available in a particular tax jurisdiction, to learn about available credits and to participate in the bidding process.

Each tax jurisdiction has different and unique legislation governing tax credits. For example, many US states offer some form of tax credit to encourage production of films or television shows in that particular state. Connecticut, Illinois, Louisiana, Massachusetts, Rhode Island and Puerto Rico, among others, provide for transferable tax credits for eligible film and television productions conducted within the particular jurisdiction. Each state establishes its own basic rules and limitations for computing the amount of the tax credit, which, in the case of the film and television production tax credit, typically means a credit equal to between 20% and 40% of qualifying in-state expenditures for eligible goods, services, and/or labor. Typical limitations and eligibility requirements can include minimum amounts which must be spent in state by the applicable production company (typical minimum amounts range from $50,000 to $300,000) and may also include a minimum amount of days spent in state during the production of the film or television show.

Depending on the jurisdiction, other eligibility requirements can include registering the production company with the Secretary of State, registering with the state to withhold personal income tax, establishing the existence of a viable distribution plan for the film or television production, and promoting diversity by making a good faith effort to hire a specified percentage of minorities. Other limitations set by the states can include content limitations (e.g., tax credits may not be available if the film or television activity is classified as obscene as defined by state laws), limitations restricting the expenditures on labor eligible for the credit to labor provided by in-state residents only, limitations restricting the amount of salary expenditures eligible for the credit to workers with a salary below a certain level, caps on the amount or value of the tax credits available per production, and limitations placed on the number of times the credit can be transferred.

In the case of film and television production tax credits, some states, such as Louisiana, require an eligibility certificate which should be applied for prior to commencement of principal photography (pre-certification). In other states, such as Connecticut, an eligibility certificate should be received within a specified time after the first qualified production expense claimed for by the production entity is incurred. The eligibility certificate typically certifies that the production company is eligible to earn the tax credit, subject to meeting other state law requirements.

Transferability is an important issue in the utilization of tax credits. In the case of film tax credits, the states that presently allow some degree of transferability include Arizona, Connecticut, Georgia, Illinois, Louisiana, Massachusetts, Missouri, New Jersey, Puerto Rico and Rhode Island. Certain of these states, such as Massachusetts, allow relatively free transferability, and in this state, as well as in Illinois, the credits may also be divided into smaller amounts and transferred. However, in some states, the film tax credits are not transferable, or can only be transferred to a limited class of transferees, or can only be transferred a limited number of times. Therefore, as this brief summary illustrates, each and every tax credit transaction must be evaluated within a complex framework of the governing law applicable to that specific tax credit. In some embodiments, the system is programmed with all of the governing rules and requirements and simplifies these complex legal rules and requirements into a user-friendly system.

An example of a state jurisdiction that offers a fully transferable film tax credit is the Commonwealth of Massachusetts. Massachusetts film and television production tax credits are fully transferable from the production company receiving the credit to any corporation or individual, and can be used to reduce all Massachusetts taxes measured by income, i.e., both taxes assessed against corporations under M.G.L. c. 63 and taxes assessed against individuals (including partnership profits and S corporation profits passed through to individuals) under M.G.L. c. 62. A Massachusetts film tax credit may be freely transferred, in turn, by the person who acquires such tax credit from the film producer, and the tax credits may be transferred an unlimited number of times, and also may be “fragmented,” meaning that the credits can be divided and subdivided into as many smaller amounts as desired by the transferor of the credit. Massachusetts has specific rules about the categories of expenses that are eligible for the tax credit, and defines those rules through formal guidance issued by the Massachusetts Department of Revenue, and also through a process of informal guidance (including emails in response to specific questions) from designated officials.

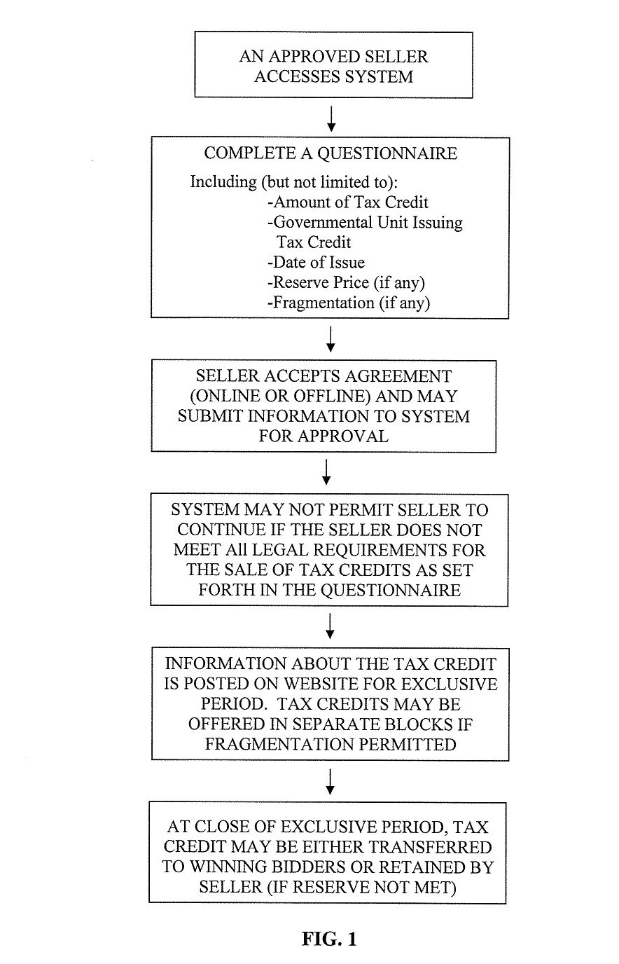

FIG. 1 is a block diagram showing a process of a Seller transferring tax credits. In one embodiment, a Seller may own and sell tax credits relating to film, TV, commercials, video games, or other tax credit programs. A system may be organized by jurisdiction, e.g., an area of the site or a separate site for federal tax credits and an area of the site or separate sites offering corresponding state tax credits. In some embodiments, no warranties may be provided by the system owner and the system owner may disclaim any obligation with respect to the proper application or interpretation of the law or any provision affecting the use, sale or transfer of tax credits, while in other embodiments some or all warranties may be provided.

In some embodiments, a Seller may access the system directly to complete a questionnaire related to the transfer of tax credits. The questionnaire may collect information such as the amount of tax credits proposed to be transferred, the jurisdiction with respect to which the tax credit is issued, the date of issue, any minimum bid requirements (e.g., a reserve price), and any other relevant information. A questionnaire may be used to elicit all relevant information relative to a specific category or type of tax credit, including whether the applicable Seller is an individual, corporation or partnership and whether the Seller expects to have tax liabilities that can be offset by the applicable tax credit. The questionnaire may be used to download the Seller's projected federal income tax return from the prior year and/or projected federal income tax return for the current year. In some embodiments, the Seller may register as a Seller, while in some embodiments the Seller may register each time he/she/they post a new auction. Using the questionnaire information, the system may permit or deny, based on governing law and appropriate administration criteria, any tax credit transfer using the system. In this way, a Seller's qualifications and legitimacy with respect to a tax credit transfer may be confirmed. In some embodiments, these processes may be accomplished offline. In some embodiments, the actual tax credit certificate or other evidence confirming the existence of the credit may be reviewed by a machine and/or a human.

Once a Seller's qualifications and legitimacy are confirmed, the Seller may be presented with an agreement relating to the terms and conditions for using the system. In some embodiments, the agreement may be presented prior to submission for approval by the Seller. In some embodiments, once the submission is approved, the agreement may be binding. In some embodiments, the Seller may be required to execute the agreement as a condition for offering tax credits on the system. After the tax credits submitted by the Seller to the system are approved and/or after the Seller executes an agreement, the tax credit may be posted on a system for an exclusive period of time (i.e., the Seller may be required to agree not to sell the tax credits elsewhere during the exclusive period). The exclusive period may be determined via the agreement. In some embodiments, the Seller agrees to exclusivity for 60 days. In some embodiments, there may be fixed auction periods of one month, for example, starting at the beginning or at the end of each month. In some embodiments, if a Seller lists before day 15 of a month, they may be included in that month and the next month and if the Seller lists after day 15 of a month, they may only be included in the following month.

In some embodiments, at the end of the exclusive period, the tax credit may be transferred to the highest bidder providing the reserve or minimum price of the Sellers has been exceeded. In some embodiments, the reserve price may be a minimum or low price which is visible to buyers. To protect profits, a Seller may place a reserve price on the tax credits to ensure a minimum sale price. The Seller may agree to keep an offer open for a specific period of time on the system (or other venue) on an exclusive basis (i.e., the tax credits will not be offered to another bidder through other means). In the event that a reserve price is not met, no transfer agreement will be reached and the Seller will be free to offer the tax credits for sale elsewhere or extend the exclusivity period. If the reserve price is met, the person making the highest bid for the tax credits will be obligated to make the purchase in accordance with the bid and the Seller will be obligated to transfer the tax credits. During the bidding process, the identity of the bidder may or may not be disclosed. The value of the lowest and highest bids may be shown to all other bidders. In some embodiments, the Seller or the system may have the option to display the bidding range, which may encourage higher bids.

In some embodiments, the Seller may list his credits and have the credits approved. Then those approved credits and/or any other credits for a particular state may be aggregated on the back-end of the system (and without knowledge of the buyer) and only one auction including the total amount of aggregated credits is displayed to the buyer. Effectively, there may be only one auction per state at a given time for tax credits currently shown to the buyer. In some embodiments, with credits available in the future, separate auctions may be shown and may be categorized by quarter and year when they are expected to become certified (e.g., issued). For example, in Louisiana, all credits immediately available that are approved and posted for sale in one month will be shown as part of one auction. Credits available in the future may be aggregated with other future credits and shown together if they become available in the same quarter or year and separately if their availability is different.

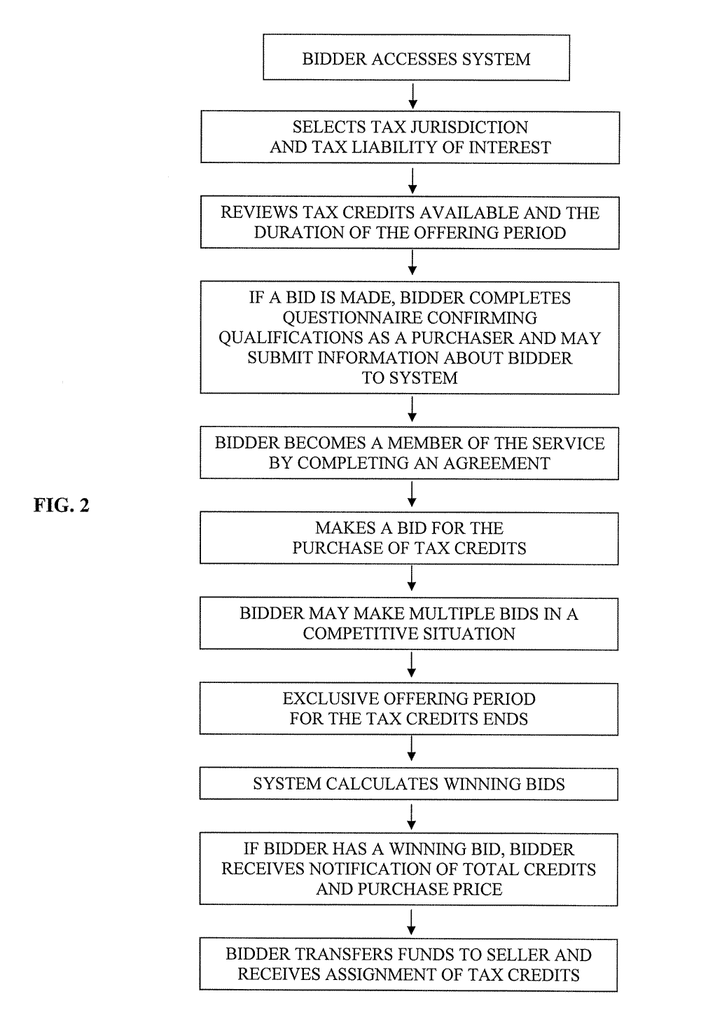

FIG. 2 is a block diagram showing a process of a person or entity bidding to purchase tax credits (such person or entity is referred to herewith as “Bidder”). Upon beginning the process, a Bidder may access the system to view the availability of transferable tax credits for purchase by entering the Bidder's estimated tax liability (or the amount of credits that the Bidder is searching for). Next, the Bidder may select the jurisdiction of interest, which allows the Bidder to review the total amount of tax credits available in the respective offering period (which may be a fixed time period, such as one calendar month). To make a bid, the Bidder may complete a questionnaire confirming Bidder's qualifications as a purchaser. The questionnaire, upon completion, may be reviewed through the use of an Administrative user interface (“Admin interface”). The Admin interface will decide whether to authorize the user and thereby create an account for such user. After the Bidder's qualifications are confirmed, the Bidder completes an agreement with respect to its use of the system, including without limitation, the bidding on, and potential purchase of, tax credits. In some embodiments, the agreement may be accepted at least by Bidder when the questionnaire is submitted. Upon execution and delivery of the agreement, the Bidder may bid for the purchase of tax credits. A Bidder may also make multiple bids when the bidding is competitive. For example, a Bidder will be able to view the latest highest bid for the applicable tax credits on the system, and will be able to post a higher bid through the service, which again may be out-bid by another party.

In use, the system may allow the Bidder to set a minimum and maximum range of bids for the applicable block of tax credits, and the system will automatically increase any bid by a predetermined or an agreed upon increment within the Bidder's range to ensure the Bidder has the highest bid until such time, if at all, that the bid goes beyond the maximum within the Bidder's range, at which point the Bidder may continue to make new bids through imputing new entries in the system. After a specified period of time, the exclusive offering period for the tax credits ends. The system may then determine the allocation of tax credits, in some embodiments, through the following process: all bids in an auction may be ranked from high price to low price and tax credits may be allocated starting with the highest bidder and then each subsequent bidder until the total inventory of credits is exhausted.

In some embodiments, whether or not there is any reserve price for the applicable tax credit may be established by the Seller, and if there is a reserve price, the system may determine whether this has been met or exceeded. The Bidders who submit winning bids will be informed that they have the winning bid and may be required to purchase the tax credits under the terms of the agreement. The Bidder may then be required to transfer funds to the Seller to complete the transaction. In addition, in the event that a Bidder with the lowest qualifying bid does not receive a full allocation of the Bidder's requested tax credits, such Bidder may be required to purchase a pro-rated portion of the Bidder's requested tax credits at the bid price. For example, in an auction with two Bidders have credits available of $1,000,000 and where the minimum bid price is $0.80, Bidder 1 bids $0.80 for all $1,000,000 credits and Bidder 2 bids $0.82 for $10,000 credits, Bidder 2 will receive its full allocation of tax credits at a bid price of $0.82, whereas Bidder 1 may be required to purchase $990,000 of tax credits at $0.80.

In one embodiment, a Bidder may specify a particular tax credit in which the Bidder has an interest, and the Bidder may then be required to acknowledge awareness of important legal information related to the credit. In some embodiments, this process may be accomplished through the use of various click-through screens in web-based applications. In some embodiments, the Bidder may be informed of the state law requirements related to the class of credit on which the prospective Bidder wishes to bid. For example, a potential Bidder for Connecticut film and television tax credits might be asked to acknowledge the Bidder's awareness that the credits can only be used by a corporate taxpayer. Another example is where a Bidder for the Illinois film tax and television tax credit would be notified, and would then acknowledge, that the credit once purchased would not be transferable, and would expire after five tax years.

In some embodiments, once the screening process is completed, the Admin interface may decide whether to approve a Bidder, and upon approval, a Bidder may enter a bidding process. A bidding process may be performed using an on-line system or other similar technology. The bidding process may also be conducted through an electronic auction, over a pre-specified period of time, with minimum bid requirements and other criteria described herein.

While using the system, a Bidder may be permitted to reconfigure and “personalize” the system for more efficient use by that Bidder. For example, the Bidder may be able to identify a specific amount of tax credits for a specific state jurisdiction and a specific tax year, e.g., “I am seeking $5,000 of tax credits against Massachusetts personal income tax for tax year 2006.” As part of the registration process, the Bidder may set notification preferences seeking notice, for example via email or text messaging, about new auctions that match the Bidder's interests. For example, follow-up notification may be based on a new auction for a specific credit identified by the Bidder, or may be based on a similarity between a new auction and other auctions in which the Bidder has previously participated, for example through monitoring or bidding.

The system may enable the Bidder to attend and participate in the auction, make a bid, decide to “buy it now” at a previously stipulated price set by Seller, and add a particular bidding auction to the Bidder's personal “watch list.” Bids may be made based on the minimum bid amounts and subsequent increments established in advance by the Seller. In some embodiments, the subsequent increments may be set by the Seller, the Bidder and/or predetermined by the controller of the system. In some embodiments, one party, such as the controller of the system, may provide a choosing party, such as the Bidder or Seller, with options (e.g., $5, $50, $250, or other monetary increments) which the choosing party may elect. In some embodiments, such as during a reverse action where the Bidder posts a request, the Bidder or controller of the system may set the increment or increment options. In some embodiments, the Bidder may be notified if that Bidder's bid is outbid. The notification may include an e-mail, text messaging, telephone, instant messaging or facsimile alert that the Bidder's bid is no longer the highest and may offer information such as the current high bid and what bid amount would be required to overtake the current high bidder.

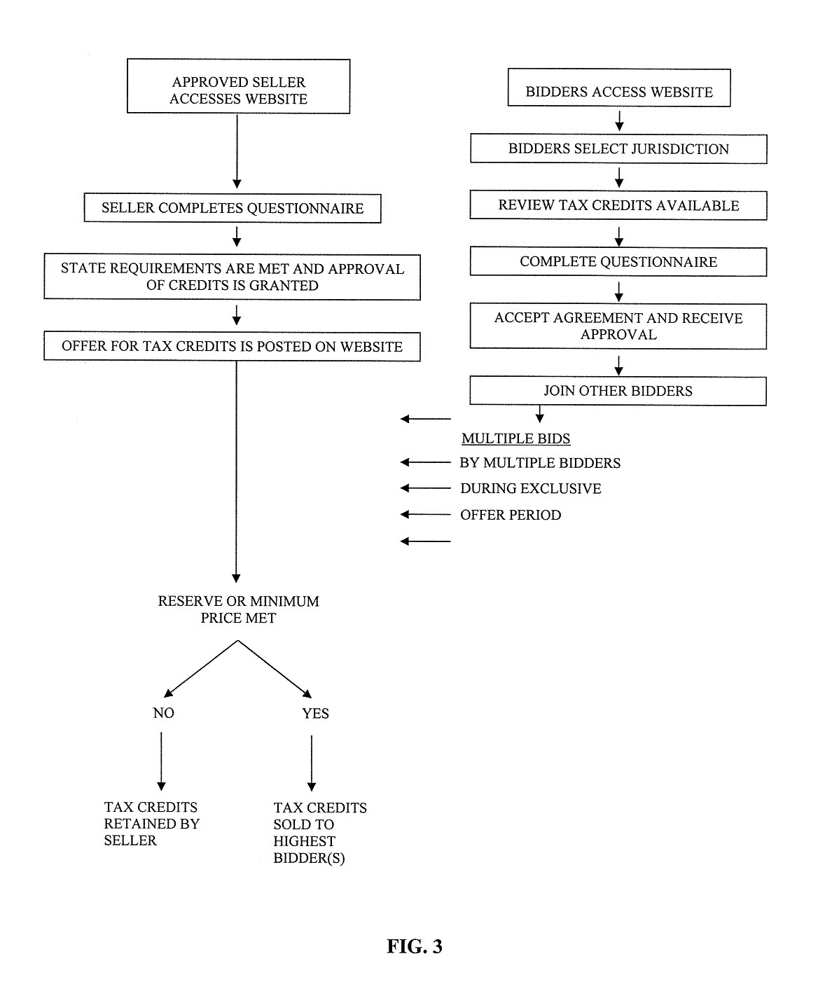

FIG. 3 is a block diagram showing a process of transferring tax credits between a Seller and a Bidder. At the beginning of the process, a Seller may access a system to transfer tax credits. Once a Seller accesses the system, the Seller may complete a questionnaire as described above. Using questionnaire information, the system may screen the validity of proposed tax transfers based on applicable law. An offer for the sale of the tax credits may be posted on the system for an exclusive period of time. At this point, a Bidder may view the offer for the sale of the tax credits. The Bidder may also choose to select a tax jurisdiction of interest, which will allow the Bidder to review available blocks of tax credits along with the corresponding offering periods. To make a bid, the Bidder may complete a questionnaire confirming its qualifications as a bidder. In some embodiments, after the system confirms the Bidder qualifications, the Bidder may then accept a legal agreement and acknowledge legal requirements with respect to their use of the system, including without limitation, the bidding on, and potential purchase of, tax credits. In some embodiments, the legal agreement occurs upon approval of the questionnaire.

Having accepted and delivered the agreement, the Bidder may bid to purchase tax credits. During the bidding process, there may be multiple bids or multiple Bidders resulting in a high bid during the exclusive offer period. In some embodiments where a reserve price is used, at the close of the exclusive offer period, the tax credit may not be transferred if the reserve price is not met. On the other hand, if the reserve price is met, the tax credits may be transferred from the Seller to the highest Bidder. If tax credits are transferred, a Bidder may provide on a confidential basis that person's tax identification number, or other information required to be reported by a transferor to the applicable taxing jurisdiction. Verification of financial ability to pay and other criteria will be taken from credit cards or other sources of electronic payment and electronic funds transfer. Security measures known in the art may be implemented to verify and track credits, to make sure lost or stolen cards are not used to “cash in” on these relatively liquid tax credits. In some embodiments, some of the above-mentioned steps, such as providing a tax identification number or verification, may be done before the bidding process, as not all embodiments of the present invention are intended to be limited in this respect.

After completing the transfer of tax credits, a commission and/or other fee may be charged for using the system in arranging the transfer. The commission may be a fixed percent of the value of the tax credits or a fixed percent of the gross margin realized by the Seller from the sale. A commission and/or other fee agreement may be signed between the parties as a precondition for the Seller to list the tax credits for sale on the system (or other venue provided by broker). In some embodiments, a listing fee may be charged to post the tax credits. In some embodiments, the commission fee may vary depending on the state, amount of credits posted, the total credits the Seller has ever posted or other factors, as not all embodiments of the present invention are intended to be limited in this manner.

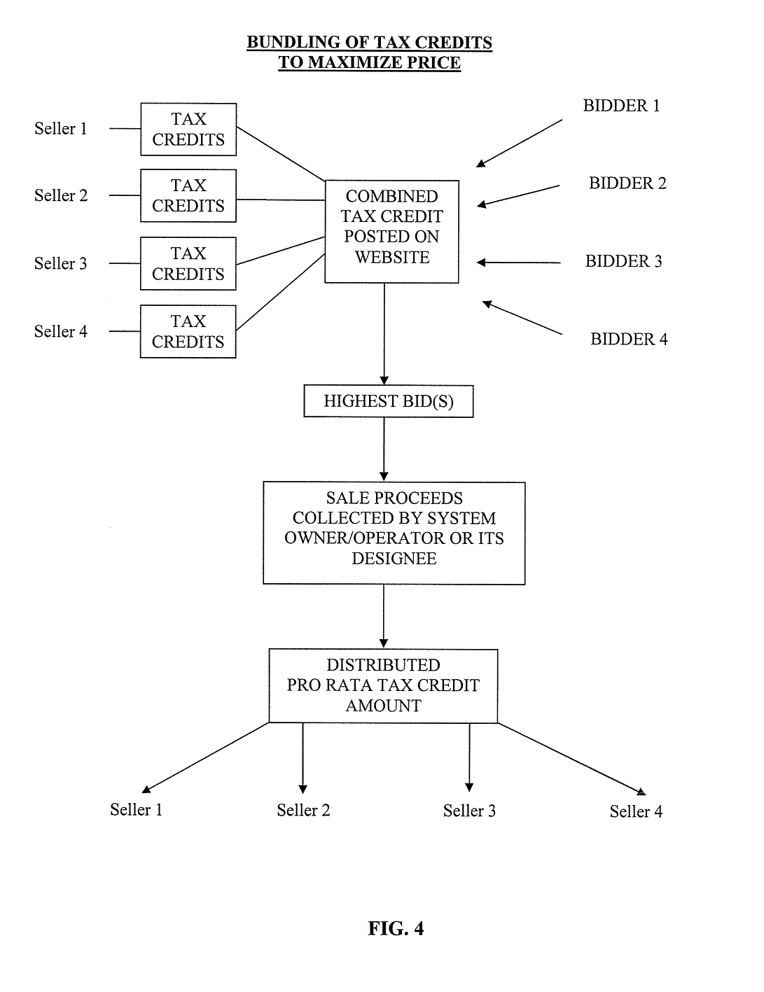

FIG. 4 is a block diagram showing a process of bundling tax credits. As shown in FIG. 4, a person or business entity that generates tax credits, e.g., Producers Sellers 1-4 in FIG. 4, may combine their tax credits to sell such tax credit in a bundle via the system. Likewise, a Bidder, such as Bidder 1-4 in FIG. 4, may make bids on a bundle of tax credits so offered. After bidding, the system may identify a high bid and the corresponding Bidder. The Bidder may then complete the sale by sending the payment to the website, the system owner, or an agent appointed by the Sellers. Once the payment is received, the system may distribute a payment to each Seller based on the amount of tax credits such Seller contributed to the bundle (e.g., payment on a pro rate basis).

In some embodiments, various Sellers in a state may submit their currently available credit inventory for listing. Once approved, these credits are aggregated into one auction for the month and displayed to buyers as one auction. Buyers may bid on whatever amount they want, however, the method of allocation of credits amongst Sellers may depend on individual Seller minimum listing prices. For example, different Sellers in the same state might have different minimum prices. Buyers would see an aggregate market price (low to high) but would not necessarily see the listing by each Seller. The allocation of multiple Sellers' inventory in the same state to Buyers may be accomplished on the back-end by any means, such as through manual processes or automated algorithm-based processes.

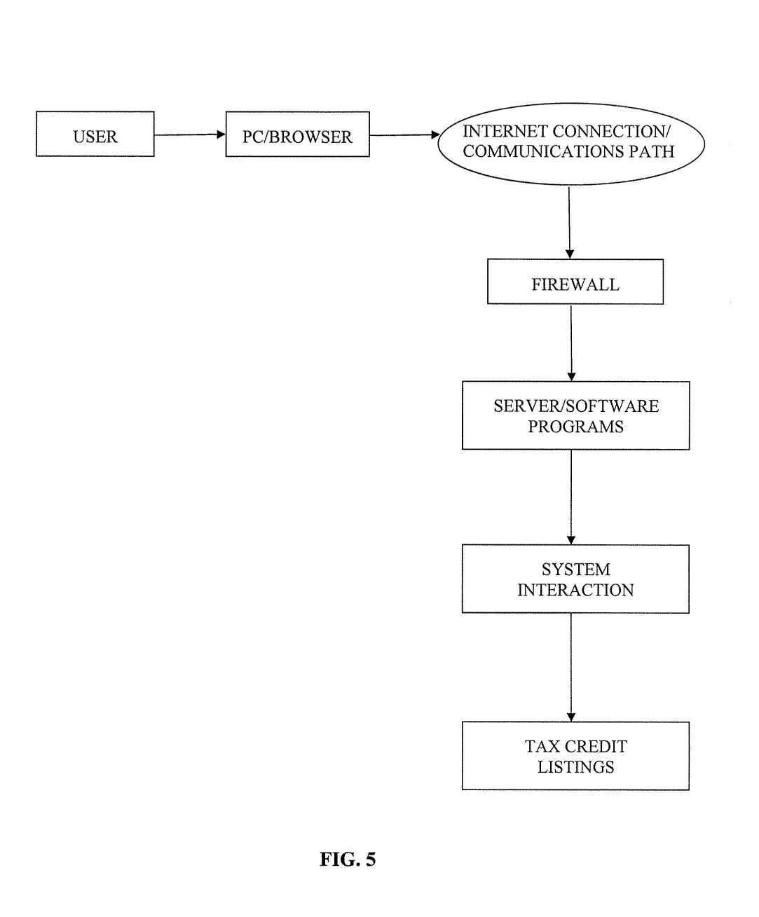

FIG. 5 is a block diagram showing certain components that may be used in a system to transfer tax credits. In an example embodiment, a user may access an Internet browser using a computer. Next, the user may create a communications path, such as an Internet connection, with a firewall. The firewall may authenticate the user and allow the user to access a server. Once on the server, the user may access a system containing a tax transfer method or corresponding apparatus using server and/or software programs. By accessing the system, the user may view, sell, and/or buy tax credits. In this way, a user may connect to a system and may transfer tax credits. The user may also access any other feature of the system such as the questionnaire described above.

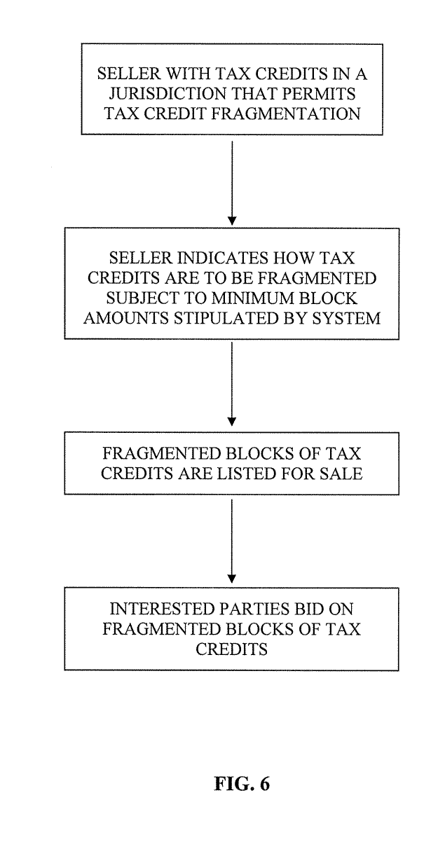

FIG. 6 is a block diagram showing the process of fragmenting and selling tax credits. A tax credit awarded by a particular taxing jurisdiction may be sold as a single block (i.e., without division) or may be fragmented into smaller blocks to the extent allowed by the applicable tax jurisdiction. In an example embodiment, a Seller may own tax credits in a jurisdiction that permits the fragmentation of tax credits for transfer/sale. The website or system may also permit a Seller to offer the tax credits in fragmented blocks as determined by the Seller. In some embodiments, the system operator may choose to designate a minimum size tax credit block. If the minimum size tax credit block is met, the tax credits are fragmented and listed on the system for sale. Once a valid amount of tax credits are listed on the system, any interested Bidders may bid on fragmented blocks of tax credits. In some embodiments, the Buyers may not necessarily know that credits are fragmented since they only see one auction. In this way, a Bidder may purchase a fragmented block of tax credits. After the sale is completed, a Bidder may transfer funds to the Seller for the purchase of the tax credits in the amount of the Bidder's final bid, and the Seller would assign the rights in and to the tax credits to the Bidder. In some embodiments there is a direct transfer of funds from the Bidder to the Seller and a direct assignment of rights in the tax credits from the Seller to the Bidder, while in some embodiments one or more third parties may act as intermediaries or liaisons between either or both exchanges between the Bidder and Seller, as not all embodiments of the present invention are intended to be limited in this manner.

A Bidder may also bid on non-issued tax credits and pay an upfront amount. That is, a Seller may be aware of tax credits that may be issued in the future (e.g., unearned tax credits), and may choose to sell on a conditional basis, tax credits that have not yet issued but that are reasonably expected to be issued in the future. For example, a major studio may commence production of a film in a transferable tax credit state and may agree to sell at the start of production all or a portion of the tax credits that may be issued with respect to such film (i.e., before the tax credits have been issued). Users of the system may bid on the conditional right to purchase such tax credits, if and when issued by the applicable state authority. Thus, the production company is able to create a timely cash flow for the tax credits and the Bidders presumably receive a significantly greater discount, for, in effect, “advancing” proceeds to the production company “collateralized” by the potential future issuance of tax credits. It should be appreciated that in conditional credits, no payment obligation may exist until the credit is actually issued. In some embodiments, non-issued credits may be combined into auctions depending on the estimated quarter/year of their availability.

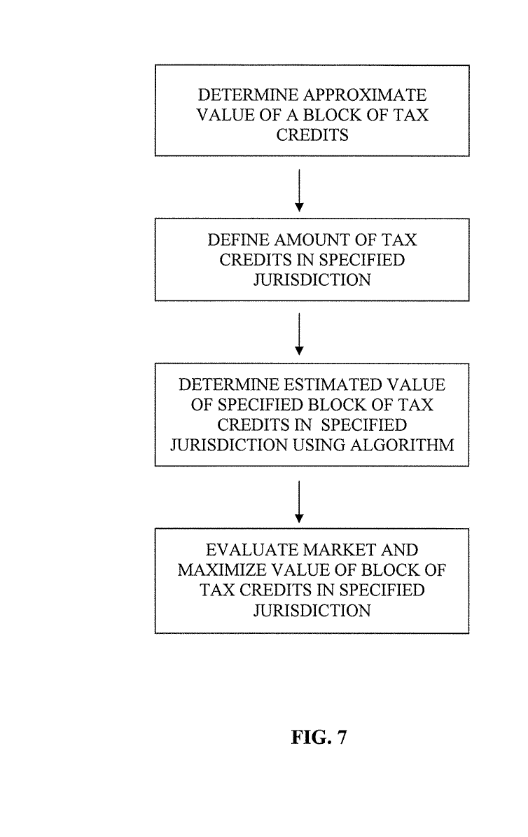

FIG. 7 is a block diagram showing a process of evaluating the value of a specific amount of tax credits in a specified jurisdiction. An algorithm may be provided through a computer interface to evaluate the value of the specified amount of tax credits. A user, whether a Seller or a Buyer, may find it valuable to understand the estimated value of an amount of tax credits in a specified jurisdiction. For example, a Seller may own tax credits in a jurisdiction and wish to determine a reasonable value prior to posting a proposed minimum price in utilization of the system. The Seller may input the information into the input field provided by the system, and the system, for example through the use of algorithms, may provide information back to the Seller on the estimated approximate value of the proposed block of tax credits. In some embodiments, the system may also provide Sellers and Bidders with data on past auctions or other metrics and/or statistics.

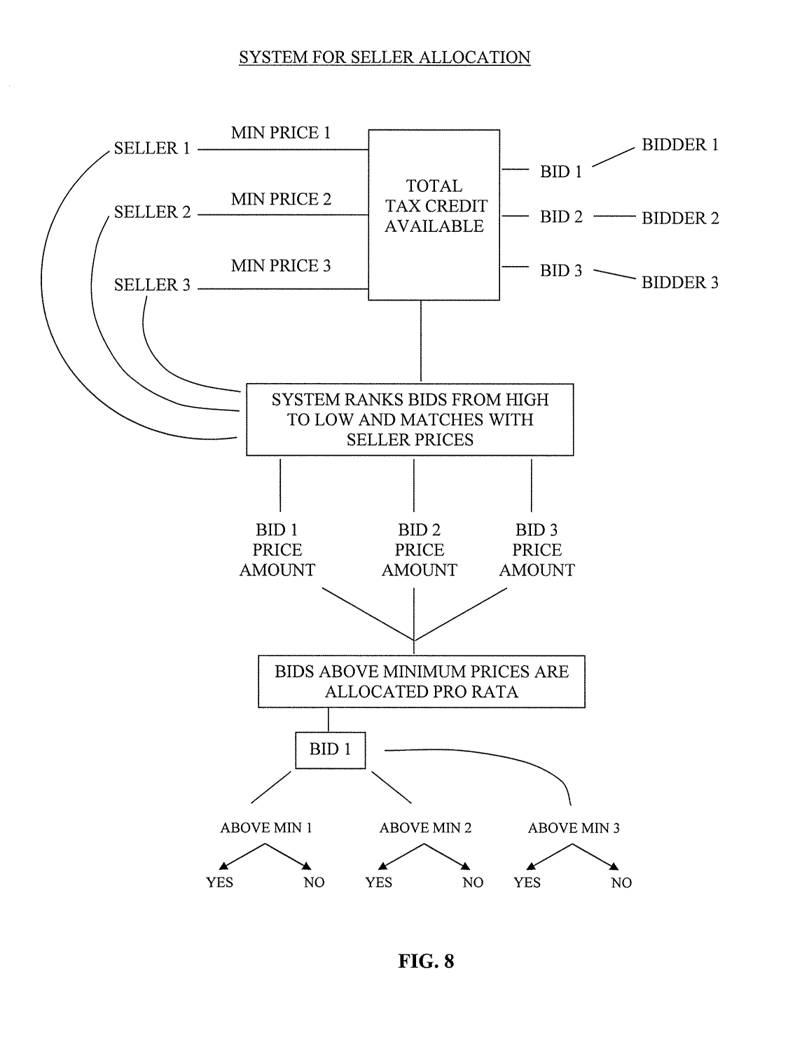

As shown in the embodiment depicted in FIG. 8, Seller inventory per state per time period may be sorted according to minimum/reserve price. Based on a variety of factors, such as the varying amounts of inventory and minimum prices, a total amount of credits available and current low/high price will be calculated and displayed to Bidders. As Bidders bid on the credits, each winning bid may be allocated among all Sellers with a minimum price below that winning bid. The allocation among the eligible Sellers may be based on the respective Seller's proportionate amount of tax credit inventory, or may be allocated according to other protocols or weighted attributes determined by the system operator.

For example, three Sellers each with an inventory of $1,000,000 of tax credits in a state with different minimum prices, set $0.60, $0.70 and $0.80 as their minimum respective prices. Therefore, the total credits available in that state would be $3,000,000 and the low price to start would be $0.60 on the dollar. As bidding occurs, any bid that is equal to or above individual minimum prices of Sellers will apply pro-rate to those Sellers. For example, a winning bid (or buy now) of $0.95 for $100,000 in tax credits would receive tax credits of $33,333 at $0.95 from each of the three Sellers mentioned above. A winning bid of $0.75 for $100,000 in tax credits would receive $50,000 of tax credits from the two lowest Sellers mentioned above.

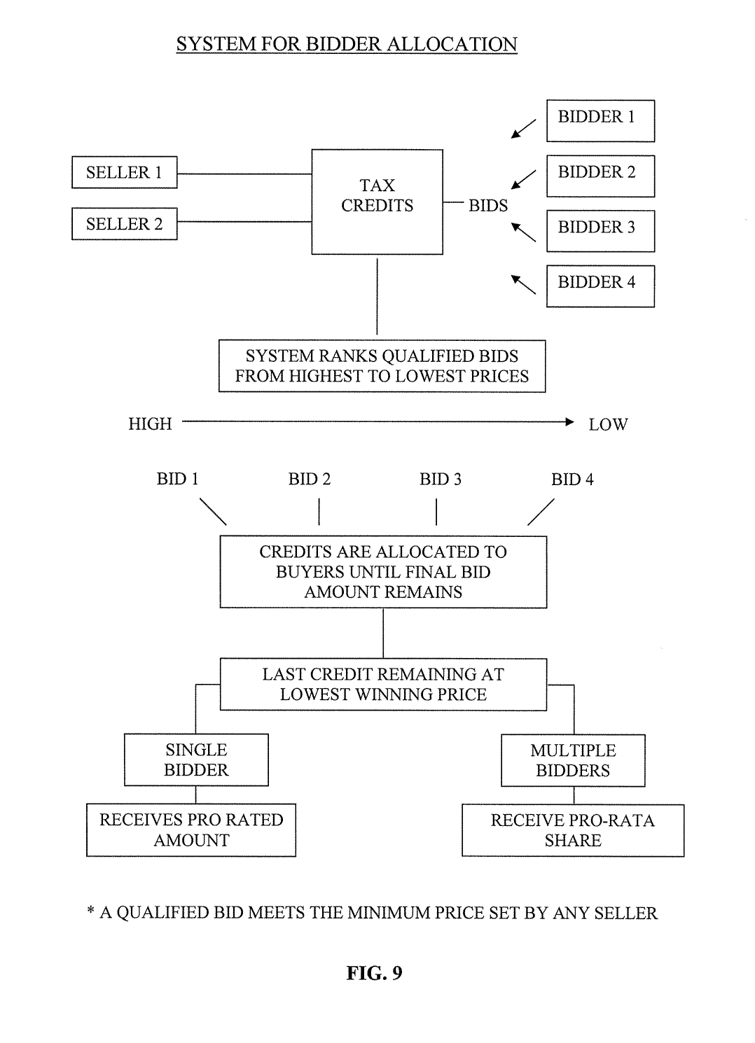

As shown in the embodiment depicted in FIG. 9, Bidders can bid on one or more tax credits from one or more Sellers. The system may rank the qualified bids from highest to lowest prices; a qualified bid may be one that meets a minimum price set by the Seller or another. The credits are allocated first to the highest Bidder, then to the second highest Bidder and so on until the last credit remains at the lowest winning price. If there is a single Bidder remaining in this allocation methodology with the lowest winning price, the single Bidder may receive a pro-rated amount of credits requested. If there are multiple Bidders in this allocation methodology with the lowest winning price, in some embodiments, the multiple bidders may each receive a pro-rate share of the credits remaining/requested.

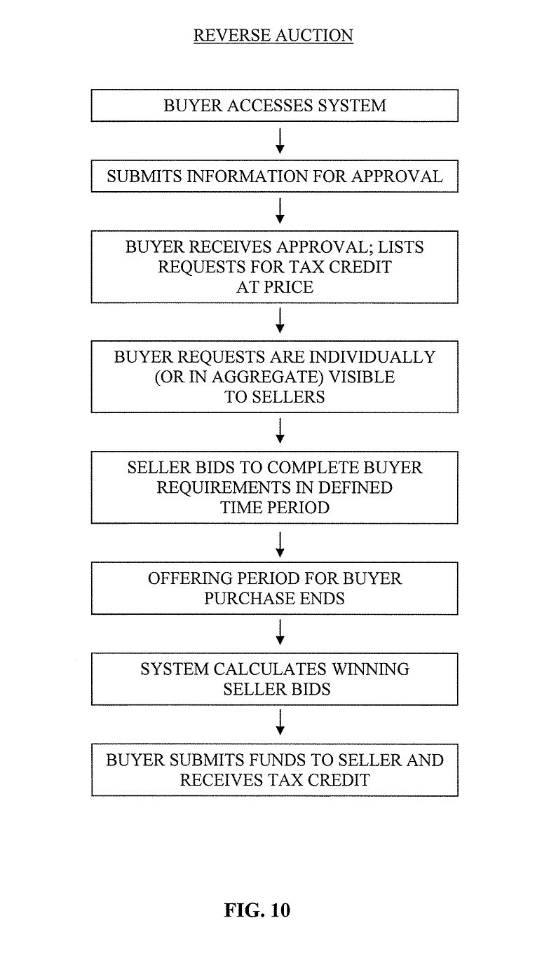

As shown in the embodiment depicted in FIG. 10, a reverse auction may involve a Bidder submitting to the system a request for the amount of tax credits that the Bidder is looking for (or the amount that a Bidder can spend for tax credits) in a particular state jurisdiction. In addition, the Bidder may submit to the system the price that the Bidder could offer for such tax credits and the time for which the Bidder's offer is valid. The system may validate that the Bidder is qualified to consummate the transaction contemplated by the request through verification of the Bidder's ability to pay (i.e. reviewing Bidder financial records, credit reports, tax returns, etc).

Once the Bidder request is approved, the system could post the Bidder requests to Sellers and display Bidder requests in an auction format for viewing by Sellers. Qualified Sellers may bid to complete Bidder requests and/or may submit parameters to the system of the amount of credits available, when the credits are available and a price for the credits. In effect, Sellers may compete to fulfill the Bidder request for a certain number of tax credits in a state at a certain maximum price (or fulfill the Bidder request for a certain amount of dollars available to spend on tax credits).

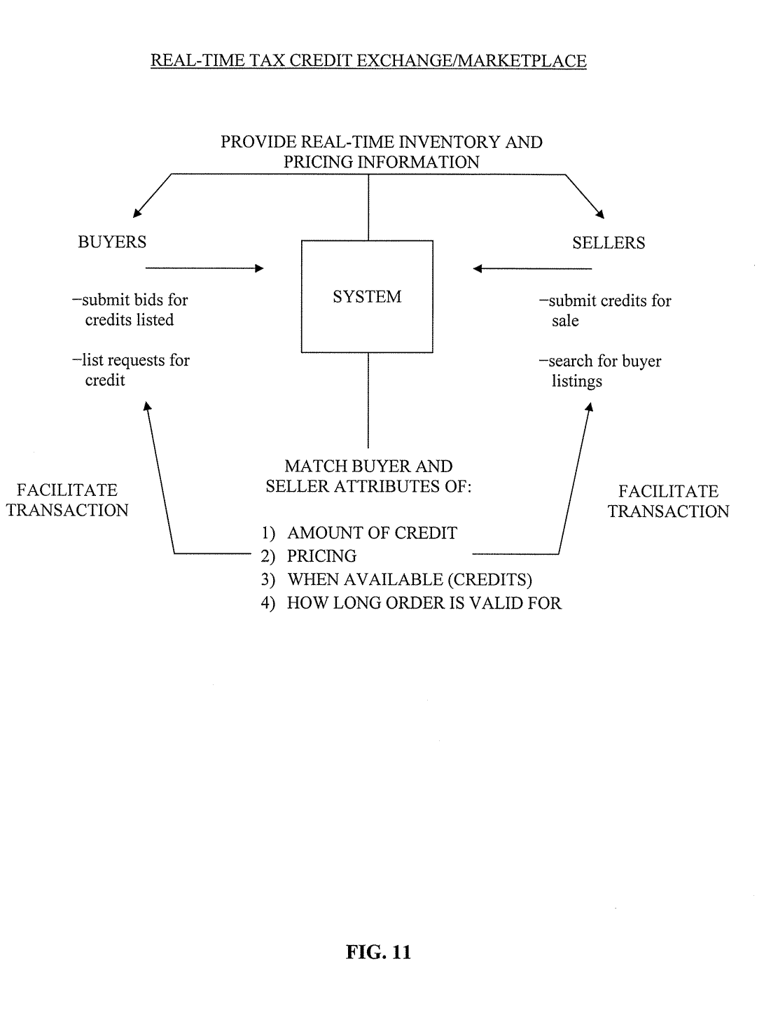

As shown in the embodiment depicted in FIG. 11, the system may be a website which may function in a manner similar to that of a real-time exchange, marketplace or online broker, or a commodities trading platform. Both Bidders and Sellers may enter an order for what they are looking for in terms of certain attributes: amount of credit, state jurisdiction, when the credit is available, pricing for the credit and/or other attributes. The Bidder or Seller may also enter a time range for how long the order is valid (one week, one month, etc). The system may match Bidder and Seller attributes and facilitate transactions where the attributes are most optimally aligned. On completion of a transaction, the Bidder and/or Seller may be charged a commission.

Credits may be transacted on a real-time basis when the system is able to match the attributes entered by a Bidder and a Seller. In some embodiments, there may be no pre-defined auction period and instead Sellers may enter the time period for which their credits would be exclusively available for sale on the system. For example, one Seller may enter 10 days while another Seller might enter 180 days for the exclusive time period for listing on the website. Sellers may also enter their pricing requirement. Bidders may enter similar information for when they could make a committed order to purchase credits, such as time period, pricing and amount. Where the system could match Seller and Bidder attributes for timing, amount and pricing in a state jurisdiction, a transaction may be completed.

The system may also provide real-time information on current market pricing and inventory availability to both Bidders and Sellers. A Bidder or Seller visiting the website could view by each state jurisdiction and what are the current prices of credits along with total availability. For example, a buyer could view existing credit inventory by state and current pricing metrics as well as past inventory data and prices.

In some embodiments, when listing their credits for sale on the website, Sellers may be given the option of choosing between an underwritten (or “minimum bidder”) auction and a traditional auction. In a minimum bidder auction, the Seller is guaranteed to receive a minimum bid (varying based on each state) from a third party underwriter, for example, a company such as taxcred.com or a partner, at the close of the auction. If the Seller elects a minimum bidder auction, the Seller may need to remit a higher commission to the underwriter or taxcred.com (regardless of whether the credits are sold for the minimum bid or a higher bid) than in an otherwise similar traditional auction. In some embodiments, Buyers may not see whether auctions have been listed by Sellers as underwritten/minimum bidder or traditional auctions. A minimum bidder auction may help ensure that the Seller receives a minimum price for its tax credits from the underwriter.

In some embodiments, the minimum bidder option may be presented to the Seller when they submit an auction for listing, by way of a check box or other tool to denote whether the auction will be a traditional or minimum bidder auction. In effecting the transfer of credits in a minimum bidder auction, the credits will be transferred from the Seller to the underwriter instead of another Bidder on the system.

In some embodiments, a Seller may determine whether it is more advantageous to sell an entire block of tax credits or whether to fragment the tax credits into smaller units. To determine how to sell the tax credits, the Seller would input different amounts of tax credits in a specified jurisdiction and receive information estimating the value of the different input specifications. In other embodiments, the Seller may use tools or functionality provided by the system or may speak with representatives or personnel of the system to determine the optimal means of fragmenting its credits on the website. In some embodiments, where tax credits can be fragmented, the system may determine how credits should be fragmented and may fragment credits as necessary to achieve optimal results on behalf of a Seller.

In another embodiment, a Bidder may want to know the difference in an estimated cost to purchase units in the same amount, but in different jurisdictions (e.g., where a Bidder has tax liabilities in multiple state jurisdictions). A user may define the same amount of tax credits in the user interface, but may also specify two or more different jurisdictions in order to compare the relative cost of buying tax credits in one jurisdiction versus a second jurisdiction.

In some embodiments, the system may be integratable with other software applications. For example, in some embodiments, the system may be integrated with tax software, such as TurboTax published by Intuit Inc., whereby when a Bidder is calculating their tax liability, they are automatically able to buy or bid on tax credits on the system through a plug-in for their tax software. Similarly, the system may be integrated at other points, such as a tax payments network.

In some embodiments, a system console may be placed or placeable at various other touch-points on the internet, such as other tax, finance, marketplace or deals websites. Viewers may be able to see the inventory and pricing of credits available through this console on other websites.

In some embodiments, a Bidder may input their exact estimated tax liability to assist them in finding the best credit or credits without overbuying. In some embodiments, the system provides an easy way for Bidders to search for available inventory. In some embodiments, the system allows Bidders and Sellers to see past transactions, what inventory is available and/or at what rate the available inventory is being traded. In some embodiments, the system enables the Sellers to get the highest price and a larger audience of Bidders while enabling the Bidders to get the credits at the lowest price in a competitive manner and from a large body of Sellers. In some embodiments, the system creates increased efficiency in buying and selling tax credits. Although tax credits are often described herein as “a dollar-for-dollar” reduction, “dollar-for-dollar” is intended to include both a 1:1 and non 1:1 reductions, as some tax credits may result in a non 1:1 reduction, such as a 2:1, 3:1, 1:2, 1:3, 0.99:1.0, 1.0:0.99, 0.95:1.0, 1.0:0.95, 0.80:1.0, 1.0:0.80, or any other ratio. Not all embodiments of the present invention are intended to be limited in this respect.

It should be appreciated that tax credits may refer to any type of tax credit, such as a federal, state, local or foreign transferable tax credit, and from any source, such as land conservation, research and development, capital investment, historical district, coal mining, economic development, environmental development, family and social needs, farming, worker training, entertainment/film or any other type of credit for taxes, as not all embodiments of the present invention are intended to be limited in these respects.

The processing performed by the system described herein may be performed by a general-purpose computer alone or in connection with a specialized processing computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

It should also be appreciated that there are many steps described herein which may be accomplished via a variety of means including manually and/or by a computer as well as in person, over the phone, remotely and/or via the internet. Some steps may be accomplished using different means and techniques than other steps, as not all embodiments of the present invention are intended to be limited in these respects. For example, in some embodiments, the majority of the above steps are accomplished using a website where a Seller and a Bidder may both use the internet to access a website set up by a controller of the system. Many of the above steps may be displayed on a computer monitor of the Seller and/or Bidder and they may input information via their computer or other remote device from their own home, office or other location. Further, offline brokers may work offline, talking with Sellers to gather information and the offline broker may communicate the information to the controller of the system who may post the information on the system; thus, both the Seller and offline broker may not interact directly with the system.

It should further be appreciated that in some embodiments, the system may provide all legal requirements and restrictions for the Bidder and/or the Seller, such that the users need not worry about consulting an attorney or other legal assistance to know that their actions are legal. In some embodiments, the system may offer legal guidelines, but not represent or warrant the guidelines and may suggest that users consult their attorney or obtain other legal advice before proceeding with the transaction. In some embodiments, the system may provide no legal information. Not all embodiments of the present invention are intended to be limited in this matter and different embodiments may provide different levels of legal information and different degrees of representations and/or warranties about the accuracy and completeness of the legal information.

It should be appreciated that the tax credits may be purchased from the Sellers by the controller of the system or by a third party. In some embodiments an agent, representative or third party may conduct transactions on behalf of a Seller or Bidder. Any or all interactions between the controller of the system, an agent or a third party and the Seller or the Bidder may be conducted offline or on the system. Further, unless the context requires otherwise, all words used herein in the singular number shall extend to and include the plural, all words in the plural number shall extend to and include the singular, and all words in any gender shall extend to and include all genders. Not all embodiments of the present invention are intended to be limited in these respects.

It should be understood that the system and methods described herein may be used to buy, sell, broker, or otherwise transfer tax credits. It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for transferring tax credits comprising:
a system layer receiving at least one bid from at least one bidder for a plurality of tax credits, the system layer connecting the at least one bidder to an application layer via a communications path and forwarding the at least one bid to the application layer;
the application layer determining whether the at least one bid from the at least one bidder is a bid which is highest for the plurality of tax credits; and
a display displaying the highest bid for the plurality of tax credits.

2. The system of claim 1 wherein the plurality of tax credits are offered for sale by a seller.

3. The system of claim 2 wherein the seller sets a minimum price for the plurality of tax credits.

4. The system of claim 1 wherein the application layer creates a bid time period during which the plurality of tax credits are available for purchase.

5. The system of claim 1 wherein, using a questionnaire, the application layer qualifies the at least one bidder to bid on the plurality of tax credits or qualifies a seller to offer the plurality of tax credits.

6. The system of claim 1 further comprising a commission agreement completed by a seller to sell the plurality of tax credits.

7. The system of claim 1 further comprising the application layer issuing a commission to a system owner based on a sale or exchange of the plurality of tax credits, wherein the commission is a fixed percent of a value of the plurality of tax credits.

8. The system of claim 1 further comprising the application layer issuing a commission to a system owner based on a sale or exchange of the plurality of tax credits, wherein the commission is a fixed percent of a gross margin realized by a seller from the sale or exchange of the plurality of tax credits.

9. The system of claim 1 wherein the application layer determines a winning bid for the plurality of tax credits based on the highest bid and transfers the plurality of tax credits to a winning bidder who submitted the winning bid upon payment of the winning bid.

10. A method for transferring tax credits comprising:
offering a plurality of tax credits for sale;
starting a bid time period;
qualifying at least one bidder to bid on the plurality of tax credits;
receiving at least one bid from the at least one bidder for the plurality of tax credits;
displaying bids from lowest to highest for the plurality of tax credits;
ending the bid time period;
determining at least one winning bid for the plurality of tax credits based on the which bid was highest; and
transferring the plurality of tax credits to at least one winning bidder who submitted the at least one winning bid upon payment of the at least one winning bid.

11. The method of claim 10 wherein a seller offers the plurality of tax credits for sale.

12. The method of claim 11 further comprising setting the bid time period.

13. The method of claim 10 further comprising setting a minimum price for the plurality of tax credits.

14. The method of claim 10 further comprising completing a questionnaire to qualify as one of the at least one bidders.

15. The method of claim 10 further comprising building separate blocks of tax credits by multiple sellers into a single offering of the plurality of tax credits.

16. The method of claim 10 further comprising providing a commission to a system owner based on a sale or exchange of the plurality of tax credits and wherein the commission payable to the system owner is a fixed percent of a value of the plurality of tax credits.

17. The method of claim 10 further comprising providing a commission to a system owner based on a sale or exchange of the plurality of tax credits and wherein the commission payable to the system owner is a fixed percent of a gross margin realized by a seller from the sale or exchange of the plurality of tax credits.

18. The method of claim 10 wherein the plurality of tax credits are a plurality of unearned tax credits and wherein said transferring step further includes transferring the plurality of unearned tax credits to the at least one winning bidder after the plurality of unearned tax credits issue, upon payment of the at least one winning bid.

19. A method for transferring tax credits comprising:
receiving a plurality of tax credits for sale;
fragmenting the plurality of tax credits into one or more groups of tax credits;
starting a bid time period for the one or more groups of tax credits;
qualifying at least one bidder to bid on the one or more groups of tax credits;
receiving at least one bid from the at least one bidder for a selected group of tax credits from the one or more groups of tax credits;
displaying bids from lowest to highest for the selected group of tax credits;
ending the bid time period;
determining at least one winning bid for the selected group of tax credits based on at least one bid which is highest; and
transferring the selected group of tax credits to at least one winning bidder submitting the at least one winning bid.

20. The method of claim 19 wherein the plurality of tax credits are a plurality of unearned tax credits and wherein the transferring step further includes transferring the plurality of unearned tax credits to the at least one winning bidder after the plurality of unearned tax credits issue.
